(19) United States
(12) Patent Application Publication
(10) Pub. No.: US 2013/0127418 A1
(43) Pub. Date: May 23, 2013

(54) ELECTRIC VEHICLE AND CHARGING CONTROL METHOD FOR BATTERY THEREOF

(71) Applicants: Won Jin Oh, Incheon-si (KR); Sun Yong Kim, Goyang-si (KR)

(72) Inventors: Won Jin Oh, Incheon-si (KR); Sun Yong Kim, Goyang-si (KR)

(21) Appl. No.: 13/813,906

(22) PCT Filed: Aug. 1, 2011
(86) PCT No.: PCT/KR2011/005643

§ 371 Date: Feb. 1, 2013

(30) Foreign Application Priority Data
Aug. 2, 2010 (KR) 1020100074753

(51) Int. Cl. B60L 11/18

(52) U.S. Cl. CPC B60L 11/1809
USPC 320/109; 320/137

(57) ABSTRACT

The present invention relates to an electric vehicle and a charging control method for a battery thereof. An electric vehicle having a high-voltage battery which supplies driving power to a plurality of electric field loads comprises: a charger which is connected with an external power source to charge the high-voltage battery; a vehicle control module (VCM) which controls connection between the charger and the high-voltage battery; a battery management system (BMS) manages the state of the high-voltage battery according to the charging of the high-voltage battery or the supply of operating power from the high-voltage battery; and a voltage detection unit which detects and reports the charged state of the high-voltage battery to the battery management system, wherein the charger comprises a charger control unit, which controls to perform a power saving mode to minimize power consumption by interrupting the transmission of a driving signal for driving of the vehicle control module and battery management system when the charging of the high-voltage battery has been completed. Accordingly, even though the electric vehicle is left as it is after having been fully charged, the high-voltage is automatically charged, which makes it possible to stably operate the electric vehicle system.

### TECHNICAL FIELD

The present invention relates to an electric vehicle and a battery charging control method thereof, and more particularly to an electric vehicle which prevents a high-voltage battery from being discharged upon completion of charging of the high-voltage battery, and is rechargeable after having been discharged such that the high-voltage battery state can be optimally maintained, and a method for controlling charging of a battery of the electric vehicle.

### BACKGROUND ART

Electric vehicles (EVs) have been actively studied because they are the most promising solution to pollution and energy problems.

Electric vehicles (EVs) are mainly driven by an AC or DC motor using power of a battery. The electric vehicles are broadly classified into battery powered electric vehicles and hybrid electric vehicles. In the battery powered electric vehicles, a motor is driven using power of a battery, and the battery is recharged after stored power is consumed. In hybrid electric vehicles, a battery is charged with electricity generated via engine driving, and an electric motor is driven using the electricity to realize vehicle movement.

The hybrid electric vehicles may further be classified into serial and parallel types. In the case of serial hybrid electric vehicles, mechanical energy output from an engine is changed into electric energy via a generator, and the electric energy is fed to a battery or motor. Thus, the serial hybrid electric vehicles are always driven by a motor similar to conventional electric vehicles, but an engine and generator are added for the purpose of increasing range. Parallel hybrid electric vehicles may be driven using two power sources, i.e. a battery and an engine (gasoline or diesel). Also, parallel hybrid electric vehicles may be driven using both the engine and the motor according to traveling conditions.

With recent development of motor/control technologies, small high-output and high-efficiency systems have been developed. Owing to replacing a DC motor by an AC motor, electric vehicles have accomplished considerably enhanced output and power performance (acceleration performance and maximum speed) comparable to those of gasoline vehicles. As a result of promoting a higher output and higher revolutions per minute, a motor has achieved reduction in weight and size, and consequently reduction in the weight and size of a vehicle provided with the motor.

A general battery charging device for use in an electric vehicle receives energy from an external power source to charge a high-voltage battery with energy, and starts driving the vehicle using the energy stored in the battery. Assuming that a plug of the electric vehicle is connected to an external power supply so that the electric vehicle is charged with electricity, power of loads in the electric vehicle is consumed after completion of battery charging of the electric vehicle connected to the external power supply. After lapse of a long period of time after completion of such battery charging, the battery is naturally discharged even though the fully-charged battery is plugged into a socket.

In addition, assuming that the plug of the electric vehicle is connected to the socket, a charger, a controller, a relay, etc. of the electric vehicle continuously receive electricity although battery charging is completed, resulting in the occurrence of unnecessary power consumption.

### DISCLOSURE

### Technical Problem

Therefore, the present invention has been made in view of the above problems, and an object of the present invention is to provide an electric vehicle and a battery charging control method thereof, which can prevent a high-voltage battery from being discharged after lapse of a predetermined time on the condition that the electric vehicle is plugged into a socket, and can recharge the battery although the battery is discharged.

### Technical Solution

In accordance with one aspect of the present invention, the above and other objects can be accomplished by an electric vehicle including a high-voltage battery for supplying drive power to a plurality of loads including: a charger connected to an external power supply so as to charge the high-voltage battery; a vehicle control module (VCM) for controlling connection between the charger and the high-voltage battery; a battery management system (BMS) for managing a state of the high-voltage battery according to either charging of the high-voltage battery or supplying of an operating power from the high-voltage battery; and a voltage detection unit for detecting a State Of Charge (SOC) state of the high-voltage battery, and transmitting the detected SOC state to the battery management system (BMS). The charger includes a charger controller configured to perform, upon completion of charging of the high-voltage battery, a long term storage mode in which transmission of a wake-up signal for driving the vehicle control module (VCM) and the battery management system (BMS) is stopped for minimum power consumption.

In accordance with another aspect of the present invention, a battery charging control method for an electric vehicle including a high-voltage battery for supplying drive power to a plurality of loads includes: performing a charging mode for charging the high-voltage battery; and upon completion of the battery charging, entering a long term storage mode for minimizing power consumption of the high-voltage battery.

### Advantageous Effects

In accordance with the embodiments of the present invention, the electric vehicle is connected to a socket so that it is charged with electricity. If the electric vehicle has been completely charged, the electric vehicle can be automatically recharged. Although the charged electric vehicle has been neglected for a long time, it is ready to prepare for traveling under a completely charged state such that the electric vehicle can immediately run as necessary.

If the electric vehicle is completely charged by connecting to a socket, the entire system other than a specific part for detecting a battery voltage is powered off, such that power consumption is minimized, resulting in reduction of unnecessary power consumption. The amount of discharged energy is reduced so that energy efficiency can be increased.

Although the electric vehicle is left alone for a long time, the charging system automatically attempts to recharge the electric vehicle by monitoring a state of the high-voltage battery, such that an optimum charging state of the electric vehicle can be maintained irrespective of an unsupervised time and the electric vehicle can be driven at a random time under a completely charged state.

### DESCRIPTION OF DRAWINGS

The above and other objects, features and other advantages of the present invention will be more clearly understood from the following detailed description taken in conjunction with the accompanying drawings.

FIG. 1 is a block diagram illustrating constituent components of an electric vehicle according to an embodiment of the present invention.

FIG. 2 is a flowchart illustrating a method for controlling charging of a high-voltage battery according to an embodiment of the present invention.

FIG. 3 is a flowchart illustrating a method for controlling charging of a high-voltage battery according to an embodiment of the present invention.

### BEST MODE

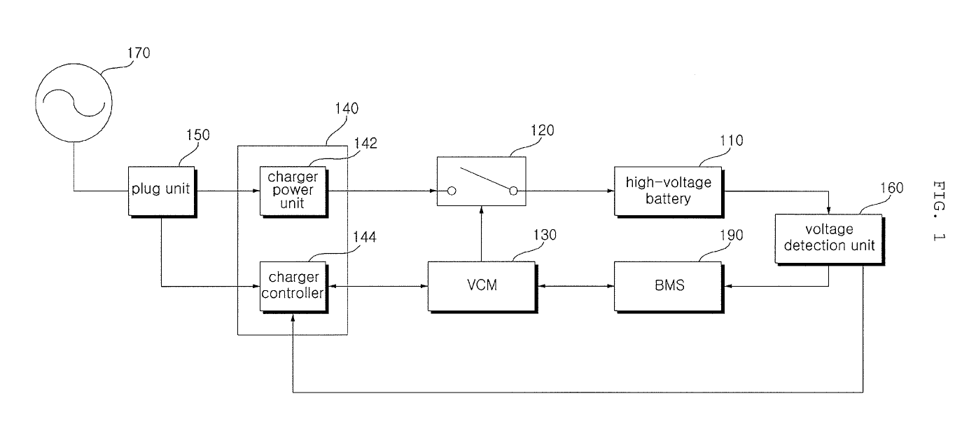

Embodiments of the present invention will be described below with reference to the attached drawings. The electric vehicle and a battery charging control method thereof according to embodiments of the present invention will hereinafter be described with reference to FIGS. 1 to 3.

The terms “module” and “unit” used to signify components are used herein to aid in the understanding of the components and thus they should not be considered as having specific meanings or roles. Accordingly, the terms “module” and “unit” may be used interchangeably.

FIG. 1 is a block diagram illustrating constituent components of an electric vehicle according to an embodiment of the present invention.

The electric vehicle according to an embodiment of the present invention will be described below with reference to FIG. 1 in terms of functional components thereof.

The electric vehicle includes a high-voltage battery 110, a power relay assembly (PRA) 120, a vehicle control module (VCM) 130, a charger 140, an auxiliary battery 150, a voltage detection unit 160, an interface unit 170, a load 180, and a battery management system (BMS) 190.

In actual implementation, two or more of these components may be incorporated into a single component, or one component may be configured separately as two or more components, as needed.

The high-voltage battery 110 includes a plurality of batteries to store high-voltage electric energy. The high-voltage battery 110 receives a driving power source, as a main power-supply source for providing energy needed for driving the electric vehicle or energy needed for driving loads, from a charging station, a vehicle charging installation, a home or an external part.

The high-voltage battery 110 is coupled to a charger power unit 142 of the charger 140 while interposing the PRA 120 therebetween, so that it can receive energy from the charger power unit 142.

A driving power source, as a main power-supply source for providing energy needed for driving the electric vehicle or energy needed for driving loads, is supplied to the VCM 130 through the BMS 190.

The voltage detection unit 160 detects the amplitude of an output voltage of the high-voltage battery 110.

In accordance with an embodiment of the present invention, if a battery output voltage detected by the voltage detection unit 160 is less than a second or third reference value, the charger controller 144 may charge or recharge the high-voltage battery.

For example, in case of basic charging of the electric vehicle, the voltage detection unit 160 detects the amplitude of an output voltage of the high-voltage battery 110, so that it checks a State of Charge (SOC) state.

For example, if the SOC state is 95% or less, the charger controller 144 performs a charging mode for charging the high-voltage battery 110. A basic charging condition of the electric vehicle is referred to as a third reference value.

In another example, the electric vehicle is charged with electricity upon receiving a control signal from the charger controller 144 on the condition that the SOC state detected by the voltage detection unit 160 is 95% or less. Upon completion of battery charging of the electric vehicle, the voltage detection unit 160 detects the amplitude of the output voltage of the high-voltage battery 110, so that it checks the SOC state. Assuming that the SOC state of 93% or higher is maintained for one or more hours, the charger controller 144 performs a Long Term Storage Mode minimizing power consumption. A condition for entering a Long Term Storage Mode (power saving mode) is defined as a first reference value.

In the long term storage mode (power saving mode), the voltage detection unit 160 detects the amplitude of the output voltage of the high-voltage battery 110 and checks the SOC state. For example, if the SOC state is reduced to 90% or less, the charger controller 144 enters a ready mode (preparation mode) in which the electric vehicle is ready to be recharged. A condition for entering the ready mode is referred to as a second reference value.

If a second reference value is less than a first reference value, the electric vehicle returns to the ready mode from the long term storage mode, and immediately moves to a charging mode, so that the high-voltage battery 110 is charged with electricity.

The power relay assembly (PRA) 120 is comprised of a switching element. Although the PRA 120 is implemented as a relay for connecting the high-voltage battery 110 to a charger power unit 142 of the charger 140, the scope or spirit of the present invention is not limited thereto, and the relay may also be comprised of a semiconductor circuit or a bimetal switch as necessary.

The PRA 120 is operated under the control of the VCM 130. The PRA 120 may switch a plurality of relays upon receiving an output signal from the VCM 130.

The PRA 120 connects the charger power unit 142 to the high-voltage battery 110, and transmits energy, supplied from the external source 170 to the charger power unit 142 through a plug unit 150, to the high-voltage battery 110, such that the high-voltage battery 110 can be charged with electricity.

The VCM 130 switches the PRA 120 on or off, and can control the converter power unit 142 by communicating with the charger controller 144 of the charger 140.

Upon completion of the battery charging operation, the VCM 130 receives an End Of Charge (EOC) signal from the charger controller 144. If the VCM 130 receives the EOC signal, it turns off a drive signal of the PRA 120, so that the charger 140 and the high-voltage battery 110 can be separated from each other.

Although the VCM 130 may use a CAN communication bus when communicating with the charger controller 144 or the BMS 190, the scope or spirit of the present invention is not limited thereto, and can also be applied to other examples as necessary.

The charger 140 may include the charger power unit 142 and the charger controller 144. The charger 140 can charge the high-voltage battery upon receiving an external AC power source.

The charger power unit 142 is connected to the high-voltage battery 110 while the PRA 120 is interposed therebetween. One side of the charger power unit 142 is connected to the plug unit 150, and the plug unit 150 is connected to a socket. If the PRA 120 is switched on, an external power source from the plug unit 150 is supplied to the high-voltage battery 110 such that the high-voltage battery 110 can be charged with electricity.

If the high-voltage battery 110 is completely charged, the charger controller 144 transmits an EOC signal through CAN bus communication. In addition, the charger controller 144 stops transmission of a wake-up signal so that it performs the ready mode.

If the SOC value detected by the voltage detection unit 160 in the ready mode is equal to or higher than a first reference value and a predetermined time elapses under the SOC state of the first reference value or higher, then the charger controller 144 enters the long term storage mode.

In other words, if a predetermined time elapses under the SOC state of a specific value or higher, the charger controller 144 powers on the voltage detection unit 160 only, and standby power consumption of the high-voltage battery 110 is reduced, so that the long term storage mode for reducing the discharge speed of the high-voltage battery 110 starts operation. The voltage detection unit 160 performs voltage detection in the long term storage mode, and transmits the detected voltage to the charger controller 144.

For example, if the SOC state of the high-voltage battery 110 is less than a second reference value in the long term storage mode, the charger controller 144 receives a low-voltage signal from the voltage detection unit 160, so that it re-performs the ready mode.

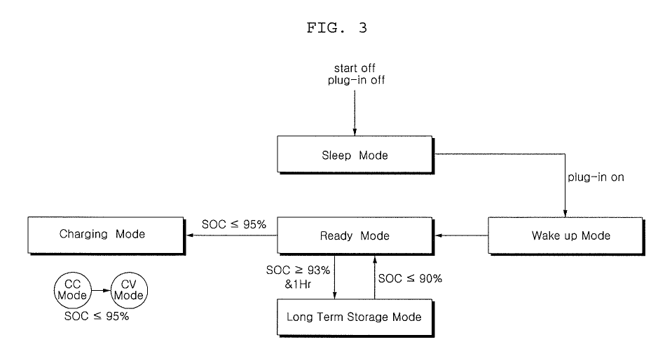

The second reference value may be arbitrarily established by a designer of the electric vehicle. Although FIG. 3 shows that a second reference value is exemplarily set to the SOC of 90% or less for convenience of description, detailed numerical values can be established by the system designer.

If the SOC state is less than a third reference value, the charger controller 144 transmits a wake-up signal to the VCM 130 so as to interconnect the external power source 170 and the high-voltage battery 110, and connects the charger 140 to the high-voltage battery 110 by closing the PRA 120, such that the electric vehicle enters the charging mode.

The third reference value may be arbitrarily established by a designer of the electric vehicle. If the SOC state is less than 95%, the electric vehicle switches from the ready mode to the charging mode as can be seen from FIG. 3, but the scope or spirit of the present invention is not limited thereto and a condition for entering the charging mode can be adjusted by the vehicle designer.

If the SOC state is equal to or higher than the third reference value in the charging mode, the charger controller 144 performs conversion of the charging mode.

In more detail, the switching of the charging mode means switching from a constant current (CC) mode into a constant voltage (CV) mode. In the CC mode, battery charging is achieved on the condition that a current value is fixed whereas a voltage value is increased. In the CV mode, battery charging is achieved on the condition that a current value is gradually decreased whereas a voltage value is fixed.

That is, if the SOC state is less than the third reference value, the electric vehicle enters the charging mode. Thereafter, if the SOC state is equal to or higher than the third reference value, the electric vehicle enters the charging mode in which a voltage value is fixed and a current value is gradually reduced such that the electric vehicle can be slowly charged.

The charger controller 144 transmits an End Of Charge (EOC) signal to the VCM 130 when the CV mode is completed.

The VCM 130 receives the EOC signal to open the relay of the PRA 120, such that the charger 140 can be separated from the high-voltage battery 110.

The plug unit 150 may connect the external power source 170 to the charger 150. The plug unit 150 is connected to a socket such that the external power source 170 is transferred to the charger power unit 142.

The plug unit 150 transmits a plug-in signal indicating connection between a plug and a socket to the charger controller 144.

The voltage detection unit 160 detects a voltage of the high-voltage battery 110, outputs the detected voltage, and transmits information regarding the detected voltage to the BMS 190.

The external power supply 170 may be a household external power source or an external power source for charging the electric vehicle. The external power supply 170 may be connected to a plug through a socket or other connection terminals. The external power supply 170 connected to the plug unit 150 may provide energy to the charger power unit 142.

The battery management system (BMS) 190 determines the remaining battery capacity and the presence or absence of charging necessity, and performs a management operation for providing the charging current stored in the battery 110 to each part of the electric vehicle.

When charging and using the battery, the BMS 190 maintains a regular voltage difference between cells of the battery, and controls the battery not to be overcharged or overdischarged, resulting in increased battery lifespan.

The BMS 190 performs management of the use of the current so as to perform long duration traveling of the vehicle, and includes a protection circuit for a supplied current.

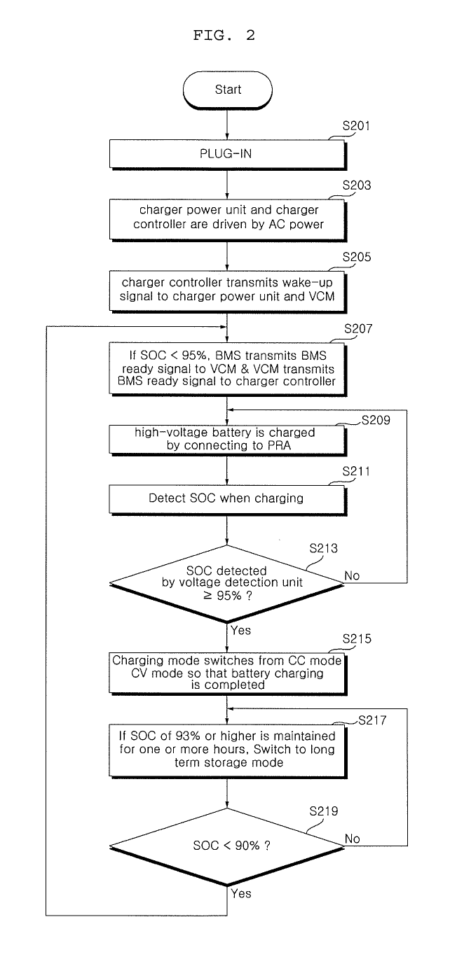

FIG. 2 is a flowchart illustrating a method for controlling charging of a high-voltage battery according to an embodiment of the present invention.

Referring to FIG. 2, the plug unit 150 is connected to the external power source 170, and transmits a plug-in signal to the charger controller 144 in step S201.

The external power source 170 is connected to the charger 140, and an external AC power is applied to the charger power unit 142, such that the charger controller 144 is driven at step S203.

The driven charger controller 144 transmits a wake-up signal to the charger power unit 142 and the VCM 130 in step S205. The VCM 130 transmits the wake-up signal received from the charger controller 144 to the BMS.

Upon receiving the wake-up signal, the BMS 190 transmits a BMS ready signal indicating satisfaction of the charging condition to the VCM 130. The VCM 130 transmits the BMS ready signal to the charger controller 144 upon receiving the wake-up signal from the BMS 190 in step S207.

The charging condition indicates that the SOC of the high-voltage battery 110 is equal to or less than the third reference value. Upon receiving the BMS ready signal, the VCM 130 transmits a relay drive signal to the PRA 120 such that the charger power unit 142 is connected to the high-voltage battery 110.

The charger power unit 142 converts an external AC power source 170, transmits the converted result to the high-voltage battery 110, and charges the high-voltage battery 110 by a predetermined condition in step S209.

When the electric vehicle is in the charging mode, the voltage detection unit 160 detects the SOC sate of the high-voltage battery 110, such that the BMS 190 transmits SOC information to the charger controller 144 in step S211.

The charger controller 144 determines whether the SOC state reaches a third reference value in step S213.

It is determined whether the SOC state is 95% or more. If the SOC state is 95% or more, the charging mode is changed from the CC mode to the CV mode, such that the charging operation is slowly completed in step S215.

If the SOC state is less than 95%, the electric vehicle continuously performs charging, and re-detects an SOC state in the charging mode.

Assuming that the electric vehicle is completely charged because the SOC state is 95% or more, if the SOC state is 93% or more and the electric vehicle plugged into a socket remains undriven for one or more hours, the charger controller 144 enters the long term storage mode in step S217.

In the long term storage mode, a charging state is changed from the SOC of 95% or less indicating a typical charging condition to another SOC of 90% or less, such that unnecessary recharging is prevented in step S219. If the SOC of the high-voltage battery 110 is reduced to 90% or less in response to natural discharging of the high-voltage battery 110, the charger controller 144 detects a low-voltage state of the high-voltage battery 110, and the SOC of 95% or less is achieved through the ready mode, such that it re-performs the charging mode in step S219.

If the high-voltage battery 110 does not reach the SOC of 90% or less, the voltage detection unit 160 monitors the SOC of the high-voltage battery.

FIG. 3 is a flowchart illustrating a method for controlling charging of a high-voltage battery according to an embodiment of the present invention.

Referring to FIG. 3, if a plug-in signal is turned off, this means a sleep mode in which no power is supplied to the converter.

If the plug-in signal is turned on, external AC power is supplied to the charger power unit 142 so that the charger controller 144 is driven.

The driven charger controller 144 transmits the wake-up signal to each of the charger power unit 142 and the VCM 130. The VCM 130 transmits the wake-up signal to the BMS 190.

Upon receiving the wake-up signal, the BMS 190 transmits the BMS ready signal indicating satisfaction of the charging condition to the VCM 130. Upon receiving the wake-up signal from the BMS 190, the VCM 130 transmits the BMS ready signal to the charger controller 144.

The charger controller 144 enters the ready mode in which the electric vehicle is ready to perform battery charging.

The charging condition indicates that the SOC of the high-voltage battery 110 is equal to or less than the third reference value. Upon receiving the BMS ready signal, the VCM 130 transmits a relay drive signal to the PRA 120 so that the charger power unit 142 is connected to the high-voltage battery 110.

If the high-voltage battery 110 has the SOC state of 95% or less, the electric vehicle switches from the ready mode to the charging mode.

In the charging mode, the charger power unit 142 performs conversion of the external AC power 170, and transmits the converted result to the high-voltage battery 110, so that the high-voltage battery 110 is charged for a predetermined time corresponding to a predetermined condition.

While the electric vehicle is being charged, the voltage detection unit 160 detects the SOC state of the high-voltage battery 110, such that the BMS 190 continuously transmits the SOC information to the charger controller 144.

The charger controller 144 determines whether the SOC state reaches a third reference value.

If the high-voltage battery reaches the SOC state of 95% or more, the electric vehicle switches from the CC mode to the CV mode so that it is completely charged.

Assuming that the electric vehicle is completely charged because the SOC state is 95% or more, if the SOC state is 93% or more and the electric vehicle plugged into a socket remains undriven for one or more hours, the charger controller 144 enters the long term storage mode.

In the long term storage mode, a reference charging value is changed from the SOC of 95% or less indicating a typical charging condition to another SOC of 90% or less, such that unnecessary recharging is prevented.

If power is persistently consumed by the voltage detection unit 160 and thus the SOC state of the high-voltage battery 110 is reduced to 90% or less as time goes by, the charger controller 144 detects a low-voltage state of the high-voltage battery 110, the high-voltage battery 110 reaches the SOC of 93% or less after passing through the ready mode, so that the electric vehicle re-enters the charging mode.

Unless the high-voltage battery 110 reaches the SOC of 90% or less, the voltage detection unit 160 monitors the SOC state of the high-voltage battery.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An electric vehicle including a high-voltage battery for supplying drive power to a plurality of loads, comprising:
a charger connected to an external power supply so as to charge the high-voltage battery;
a vehicle control module (VCM) for controlling connection between the charger and the high-voltage battery;
a battery management system (BMS) for managing a state of the high-voltage battery according to either charging of the high-voltage battery or supplying of an operating power from the high-voltage battery; and
a voltage detection unit for detecting a State Of Charge (SOC) state of the high-voltage battery, and transmitting the detected SOC state to the battery management system (BMS),
wherein the charger includes a charger controller configured to perform, upon completion of charging of the high-voltage battery, a long term storage mode in which transmission of a wake-up signal for driving the vehicle control module (VCM) and the battery management system (BMS) is stopped for minimum power consumption.

2. The electric vehicle according to claim 1, wherein:
upon completion of charging of the high-voltage battery, the charger controller stops transmission of the wake-up signal so as to enter a ready mode, and
if the SOC state detected by the voltage detection unit in the ready mode is a first reference value or higher and the resultant SOC state of the first reference value or higher is maintained for a predetermined time, the charging controller enters the long term storage mode.

3. The electric vehicle according to claim 1, wherein the charger controller provides a power source only to the voltage detection unit during the long term storage mode.

4. The electric vehicle according to claim 2, wherein the charger controller, if the SOC state of the high-voltage battery is a second reference value or less in the long term storage mode, receives a low-voltage signal from the voltage detection unit so as to release the long term storage mode, and re-enters a ready mode indicating a standby charging state.

5. The electric vehicle according to claim 1, wherein the charger controller, if the SOC state is less than a third reference value, transmits a wake-up signal to the vehicle control module (VCM) so as to connect the external power supply to the high-voltage battery, such that it charges the high-voltage battery.

6. The electric vehicle according to claim 5, wherein, if the SOC state of the high-voltage battery is a first reference value or higher in the charging mode, the charger controller switches from a constant current (CC) mode in which a current value is fixed and a voltage value is increased for battery charging, to a constant voltage (CV) mode in which a voltage value is fixed and a current value is gradually reduced for completion of the battery charging.

7. The electric vehicle according to claim 6, wherein:
the charger controller transmits an End Of Charge (EOC) signal to the vehicle control module (VCM) upon completion of the CV mode, and
the vehicle control module (VCM) opens a relay of a power relay assembly (PRA) in response to the EOC signal so that the charger and the high-voltage battery are separated from each other.

8. A battery charging control method for an electric vehicle including a high-voltage battery for supplying drive power to a plurality of loads, the method comprising:
performing a charging mode for charging the high-voltage battery; and
upon completion of the battery charging, entering a long term storage mode for minimizing power consumption of the high-voltage battery.

9. The method according to claim 8, further comprising:
upon completion of the battery charging, if a State Of Charge (SOC) state having a first reference value or higher is maintained for a predetermined time or longer, performing the long term storage mode.

10. The method according to claim 8, further comprising:
if a State Of Charge (SOC) state of the high-voltage battery is a second reference value or less in the long term storage mode, recharging the high-voltage battery.

11. The method according to claim 8, further comprising:
if a State Of Charge (SOC) state of the high-voltage battery is less than a third reference value, performing the charging mode by connecting the external power supply to the high-voltage battery.

12. The method according to claim 8, further comprising:
if the SOC state of the high-voltage battery is a third reference value or higher in the charging mode, switching from a constant current (CC) mode in which a current value is fixed and a voltage value is increased for battery charging, to a constant voltage (CV) mode in which a voltage value is fixed and a current value is gradually reduced for completion of the battery charging.

13. The method according to claim 12, further comprising:
if battery charging is completed by switching of the charging mode, separating the high-voltage battery and the external power supply from each other by opening a relay for interconnecting the high-voltage battery and the external power supply.
